(19) United States
(12) Patent Application Publication
(10) Pub. No.: US 2023/0179531 A1
(43) Pub. Date: Jun. 8, 2023

(54) CONTENT DISTRIBUTION SYSTEM

(71) Applicant: NIPPON TELEGRAPH AND TELEPHONE CORPORATION, Tokyo (JP)

(72) Inventors: Toshihito FUJIWARA, Musashino-shi, Tokyo (JP); Hiroya ONO, Musashino-shi, Tokyo (JP); Tomohiro TANIGUCHI, Musashino-shi, Tokyo (JP)

(73) Assignee: NIPPON TELEGRAPH AND TELEPHONE CORPORATION, Tokyo (JP)

(21) Appl. No.: 17/921,078

(22) PCT Filed: Apr. 27, 2020
(86) PCT No.: PCT/JP2020/018026

§ 371 Date: Oct. 24, 2022

(51) Int. Cl. H04L 47/263; H04L 67/10; H04L 1/00; H04L 43/0829; H04L 47/10; H04N 21/6405; H04N 21/24; H04N 21/238

(52) U.S. Cl. CPC H04L 47/263; H04L 67/10; H04L 1/004; H04L 43/0835; H04L 47/15; H04N 21/6405; H04N 21/2404; H04N 21/238

(57) ABSTRACT

The present disclosure aims to make it possible to transfer multicast packets at as high a rate as possible according to a state of a network, to perform high-quality and low-latency content distribution, and to perform stable multicast distribution on a network that is less likely to ensure a fixed available band such as a best-effort or wireless network.

The present disclosure is a content distribution system for converting part of communication for distribution into multicast communication, in which

a transmission-side edge server (UC/MC) applies Forward Error Correction to a multicast packet and transmits the multicast packet, a reception-side edge server (MC/UC) notifies the transmission-side edge server of information of packet loss of the received multicast packet, and

the transmission-side edge server (UC/MC) changes a transfer rate of a multicast packet to be transmitted based on the notified information of packet loss.

### TECHNICAL FIELD

The present disclosure relates to a method for converting traffic of a plurality of unicast streams having the same content identifier for different destinations from unicast into multicast, from multicast into multicast, and from multicast into unicast.

### BACKGROUND ART

Hyper Text Transfer Protocol (HTTP) streaming methods such as HLS (NPL 1) and MPEG-DASH (NPL 2) are known for video distribution using HTTP. When the same content, such as live content, is distributed simultaneously to a large number of users in HTTP streaming, loads on the server and the network are easily likely to increase because the content is communicated from the server to individual clients in unicast. If overload on the server or network congestion occurs, Quality of Experience (QoE) in viewing deteriorates, causing low video quality, video stopping, and the like.

In order to prevent deteriorating QoE, there is a technique of converting part of communication for distribution into multicast communication (NPLS 3 and 4).

FIG. 1 illustrates an example of a technique of converting part of the communication for distribution into multicast communication. In this technique, an edge server (UC/MC) 91 and a plurality of edge servers (MC/UC) 92 are disposed between origin servers 93 and pieces of user equipment (UE) 94, multicast communication is performed between the edge server (UC/MC) 91 and the plurality of edge servers (MC/UC) 92, and thus the amount of traffic resulting from transmission of the origin servers 93 and the edge server (UC/MC) 91 can be reduced to about 1/the number of pieces of UE, while keeping the existing HTTP interface for the interface between the origin servers 93 and the UE 94, in comparison with unicast distribution. As a result, the load imposed on the origin servers 93 can be reduced, and stable and high-quality live video distribution to the UE can be achieved while using existing moving image distribution servers and web-based players.

In the above-described technique of converting part of the communication for distribution into multicast communication, three layers of latency including latency in transfer from the origin servers 93 to the edge server (UC/MC) 91, latency in multicast transfer from the edge server (UC/MC) 91 to the edge servers (MC/UC) 92, and latency in transfer from the edge servers (MC/UC) 92 to the UE 94 accumulate, and thus the total latency is likely to increase (FIG. 2). In particular, because it is not possible to control re-transmission by the multicast transfer, the transmission rate of the multicast packets from the edge server (UC/MC) 91 needs to be limited. As a result, latency in the multicast transfer from the edge server (UC/MC) 91 to the edge servers (MC/UC) 92 is likely to increase.

In HTTP streaming, such increase in latency in transfer encourages switching to a lower image quality stream by Adaptive Bit Rate (ABR) control, and leads to a decrease in viewing image quality. In addition, even if the image quality does not decrease, the real-time property decreases due to the increase in latency.

Because a transmission rate of multicast packets from the edge server (UC/MC) 91 is set to an empirical value or a fixed value based on a band assured by the circuit, etc., higher-rate transmission of the multicast packets may be possible at a certain time. In addition, a large volume of multicast packets such as those of a moving image with high image quality cannot be transferred on a network that is not likely to ensure a fixed band.

Further, while in IPTV, a packet transmission rate is only required to be set to the same level as a video transmission rate because packets are continuously transferred as a stream, the present disclosure deals with HTTP streaming, and in HTTP streaming, a plurality of short-time video files constituting video content are transferred by each file in a bursting manner (intermittently), and thus it is important to reduce the transfer time.

### CITATION LIST

### Non Patent Literature

NPL 1: RFC8216

NPL 2: ISO/IEC23009

NPL 3: Fujiwara et al., IEICE technical report, CQ2019-102, 2019

NPL 4: Fujiwara et al., IEICE technical report, CQ2019-72, 2019

### SUMMARY OF THE INVENTION

### Technical Problem

The present disclosure aims to make it possible to transfer multicast packets at as high a rate as possible according to a state of a network, to perform high-quality and low-latency content distribution, and to perform stable multicast distribution on a network that is less likely to ensure a fixed available band such as a best-effort or wireless network.

### Means for Solving the Problem

To achieve the above-described object, according to the present disclosure, in a content distribution system that converts part of communication for distribution into multicast communication, a transmission-side edge server (UC/MC) adds Forward Error Correction to a multicast packet and transmits the multicast packet, a reception-side edge server (MC/UC) notifies the transmission-side edge server (UC/MC) of information of packet loss of the received multicast packet, and the transmission-side edge server (UC/MC) changes a transfer rate of a multicast packet to be transmitted based on the notified information of packet loss.

The content distribution system according to the present disclosure is a content distribution system for converting part of communication for distribution into multicast communication. The content distribution system includes

a transmission-side edge server that converts unicast communication into multicast communication and performs transmission to a multicast communication network and a reception-side edge server that converts multicast communication transmitted on the multicast communication network into unicast communication transmitted in the multicast communication. The transmission-side edge server adds Forward Error Correction to a multicast packet and transmits the multicast packet,
the reception-side edge server notifies the transmission-side edge server of information of packet loss of the received multicast packet, and
the transmission-side edge server changes a transfer rate of a multicast packet to be transmitted based on the notified information of packet loss.

A content distribution method according to the present disclosure is a content distribution method performed by a content distribution system for converting part of communication for distribution into multicast communication. The content distribution system includes

a transmission-side edge server that converts unicast communication into multicast communication and performs transmission to a multicast communication network and a reception-side edge server that converts multicast communication transmitted on the multicast communication network into unicast communication. The method includes, by the transmission-side edge server, adding Forward Error Correction to a multicast packet and transmitting the multicast packet,
by the reception-side edge server, notifying the transmission-side edge server of information of packet loss of the received multicast packet, and
by the transmission-side edge server, changing a transfer rate of a multicast packet to be transmitted based on the notified information of packet loss.

An edge server apparatus according to the present disclosure is an edge server apparatus included in a content distribution system for converting part of communication for distribution into multicast communication, the edge server apparatus being

a transmission-side edge server that converts unicast communication into multicast communication and performs transmission to a multicast communication network. The edge server apparatus adds Forward Error Correction to a multicast packet to be transmitted to the multicast communication network, and
when the edge server apparatus receives information of packet loss of a multicast packet of a reception-side edge server that converts multicast communication transmitted on the multicast communication network into unicast communication, the edge server apparatus changes, based on the received information of packet loss, a transfer rate of the multicast packet to be transmitted to the multicast communication network.

An edge server apparatus according to the present disclosure is an edge server apparatus included in a content distribution system for converting part of communication for distribution into multicast communication, the edge server apparatus being a reception-side edge server that converts multicast communication transmitted on a multicast communication network into unicast communication. The edge server apparatus

receives a Forward Error Correction-added multicast packet,
detects packet loss of the received multicast packet,
notifies a transmission-side edge server that has transmitted the received multicast packet of information of packet loss of the multicast packet, and
receives a multicast packet at a transfer rate based on the information of the packet loss notified to the transmission-side edge server.

A program according to the present disclosure is a program that causes the computer to operate each function of the apparatus of the present disclosure, and a program that causes the computer to perform each step of the method according to the present disclosure.

### Effects of the Invention

The present disclosure makes it possible to transfer multicast packets at as high a rate as possible according to a state of a network, and high-quality and low-latency content distribution and stable multicast distribution on a network that is less likely to ensure a fixed available band such as a best-effort or wireless network can be performed.

### BRIEF DESCRIPTION OF DRAWINGS

FIG. 1 illustrates an example of a technique for converting part of the communication for distribution into multicast communication.

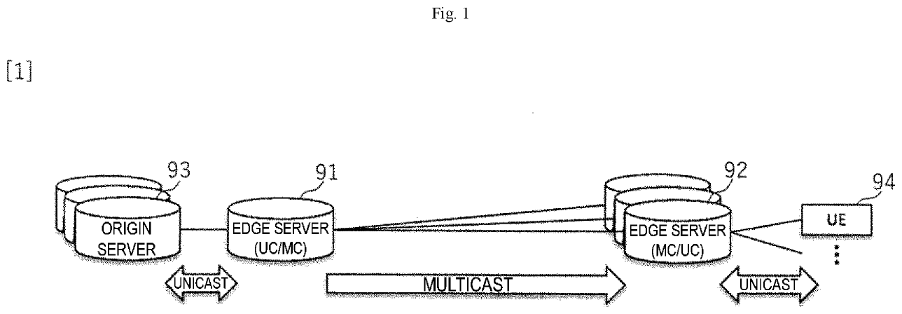

FIG. 2 is a diagram illustrating an issue of the technique for converting part of the communication for distribution into multicast communication.

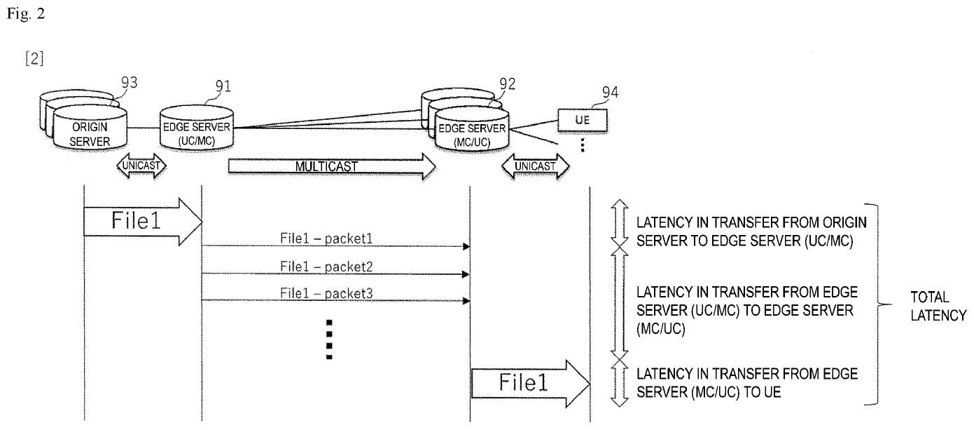

FIG. 3 illustrates an example of a system configuration illustrating an overview of the present disclosure.

FIG. 4 illustrates an example of increasing and decreasing a transmission rate.

FIG. 5 illustrates an example of detection, notification, and control of packet loss in a multicast stream.

FIG. 6 illustrates an example of an operation of an edge server (UC/MC).

FIG. 7 illustrates an example of control of an increase phase. FIG. 7(a) indicates a case in which a transfer rate is constant, and FIG. 7(b) indicates a case in which a transfer rate increases at an average rate.

FIG. 8 illustrates an example of phase control in an increase phase, a steady phase, and a decrease phase.

FIG. 9 illustrates a configuration example of an edge server (UC/MC) and an edge server (MC/UC).

### DESCRIPTION OF EMBODIMENTS

Hereinafter, embodiments of the present disclosure will be described in detail with reference to the drawings. Further, the present disclosure is not limited to the embodiments described below. These examples of the embodiments are merely examples, and the present disclosure can be implemented in forms in which various modifications and improvements are added based on knowledge of those skilled in the art. Constituent elements with the same reference signs in the specification and the drawings are assumed to be the same constituent elements.

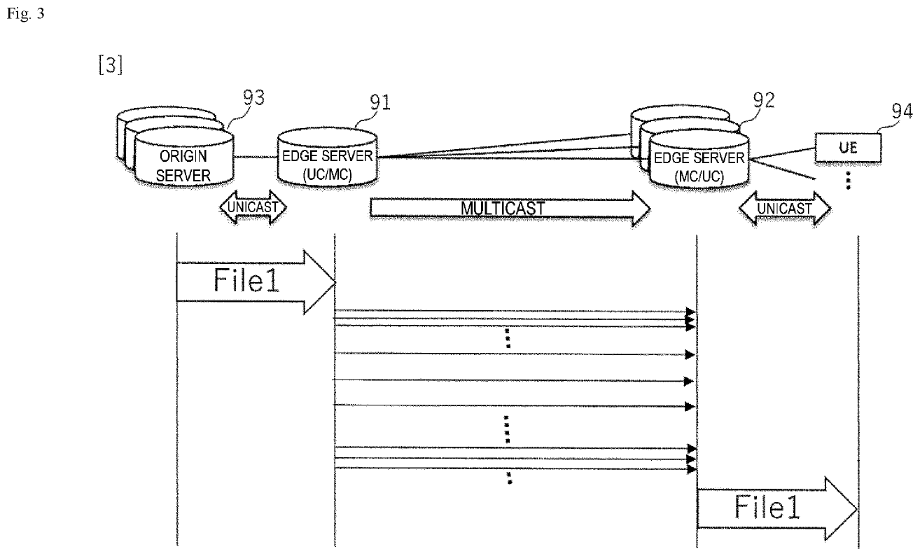

According to the present disclosure, Forward Error Correction (FEC) is added to multicast packets transmitted from an edge server (UC/MC) 91, the state of the packet loss received by an edge server (MC/UC) 92 is monitored, the monitoring information is notified by the edge server (MC/UC) 92 to the edge server (UC/MC) 91, and the transmission rate of the multicast packets transmitted from the edge server (UC/MC) 91 is dynamically changed (FIG. 3).

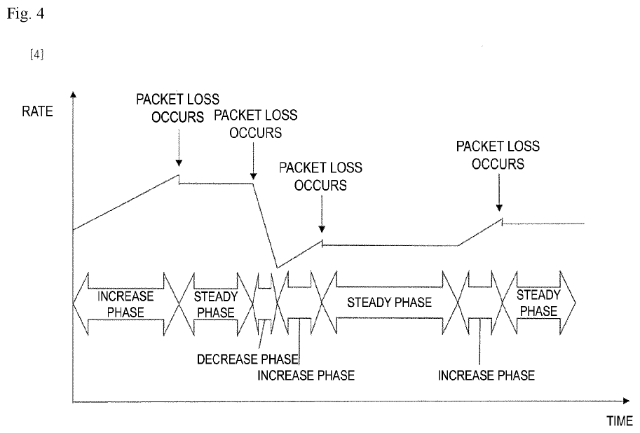

An increase or decrease in a transmission rate is according to an increase phase in which a rate gradually increases, a steady phase in which a rate is kept constant, and a decrease phase in which a rate decreases. Each phase can transition to another phase with packet loss or a timer as a trigger (FIG. 4).

As a result, by adding FEC, retransmission of packets at the time of packet loss is not required, and latency does not increase. Furthermore, by gradually increasing the rate of multicast packets in the correctable range of FEC, the multicast packets can be transmitted at an upper limit rate at which the packets can be transferred on the network or received by the edge servers (MC/UC) 92. As a result, latency that occurs during the multicast transfer can be reduced to the maximum.

In addition, in a case in which File 2 is transferred following File 1, the initial transfer rate can be the final transmission rate of File 1. In addition, in a case in which there are a plurality of files to be simultaneously transferred in multicast communication, the transmission rate can be controlled by putting the plurality of files together.

However, the control can be combined with control over each individual file. For example, by putting output queues together after the control over each individual file, the control can be performed again when the files are output. In addition, in a case in which there are a plurality of files to be simultaneously transferred in multicast communication, a change in the rate in each phase can be adjusted in control over each individual file. For example, the rate can be changed more moderately.

### Packet Loss Control

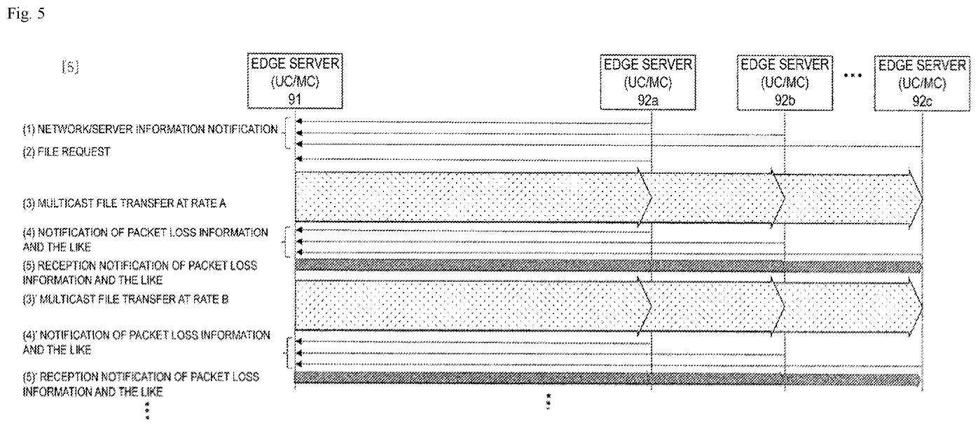

Detection, notification, and control of packet loss in a proposed multicast stream of an edge server (UC/MC) 91 and edge servers (MC/UC) 92 will be described with reference to FIG. 5. The edge server (UC/MC) 91 can receive (1) network/server information notification from a plurality of edge servers (MC/UC) 92 that are destinations of (3) multicast file transfer before performing (3) multicast file transfer. The network/server information includes a network transfer upper limit value, a transfer upper limit value set for a server, a load on a server, and the like. The edge server (UC/MC) 91 can set and control an initial transfer rate and a rate applied during transfer based on the above-described information. For example, if there is a notification of an upper limit value of 100 Mbps from the edge server (MC/UC) 92a, the upper limit of the (3) multicast file transfer can be controlled to set to 100 Mbps. Further, (1) network/server information notification is not essential.

The edge servers (MC/UC) 92 can perform (2) file request. For example, when the edge server (MC/UC) 92a makes a request for a file, the edge server (UC/MC) 91 starts the (3) multicast file transfer, and thus the edge servers (MC/UC) 92a, 92b, and 92c can start receiving the file. Further, (2) file request is not essential. For example, the edge server (UC/MC) 91 can start the (3) multicast file transfer by itself without a request from any edge server (MC/UC) 92.

One of the edge servers (MC/UC) 92 can notify the edge server (UC/MC) 91 of (4) packet loss information and the like during the multicast file transfer from the edge server (UC/MC) 91 (which will be detailed below).

After receiving the notification such as the (4) packet loss information, and the like, the edge server (UC/MC) 91 can give (5) reception notification of the packet loss information and the like in unicast communication to the edge server (MC/UC) 92 that is the notification source of the (4) packet loss information and the like, or give the notification to all of the edge servers (MC/UC) 92 in multicast communication. The (5) reception notification of the packet loss information and the like can include the information of the notification of the (4) packet loss information, and the like, and information of the transmission rate and control phase of the packets of the edge server (UC/MC) 91. The other edge servers (MC/UC) 92 that have not notified the edge server 91 of the (4) packet loss information and the like can select not to give a notification of the (4) packet loss information and the like based on the information of the notification of the (4) packet loss information, and the like, and the information of the transmission rate and control phase of the current packets and packets to be scheduled for transition of the edge server (UC/MC) 91. Thus, in a case in which another edge server (UC/MC) 91 has already been notified of packet loss, for example, redundant notifications can be avoided, and an increase in traffic of the notifications and an increase in the load on the server can be reduced. Further, the notification of (5) is not essential. By transferring the notification of (4) in multicast communication, (5) is substituted. Successively, the processing of (3) to (5) is repeatedly continued until the file transfer is completed. Further, all of the servers do not have to be synchronized or exclusive, and each of the servers can process (3) to (5) at independent timings or simultaneously.

### Packet Loss Detection/Notification

Loss of multicast packets can be detected on the reception side by adding a header with a sequence number of a real-time transport protocol (RTP), or the like to each packet and searching for a missed number among sequence numbers.

Latency and jitter of multicast packets can be detected on the reception side by adding a header with time information of a real-time transport protocol (RTP), or the like to each packet.
The reception side can detect loss when there is no new packet received based on the time elapsed from the arrival time of the previous packet.
The packet loss notification information can include sequence number information of a lost packet to determine a lost packet. The packet loss notification information can further include other additional information such as a reception latency, jitter, and the like.

The packet loss notification from the edge server (MC/UC) 92 can be a negative acknowledgment (NACK) that is notified of only at the time of packet loss. This can reduce a traffic load caused by the packet loss notification and a processing load on the edge servers (MC/UC) 92.

Although the packet loss notification from the edge servers (MC/UC) 92 can be evaluated for each arrived packet and the edge servers (MC/UC) 92 can be notified of the evaluation, the servers can also be notified of information in which reception states of a plurality of packets are gathered. This can reduce a traffic load caused by the packet loss notification and a processing load on the edge servers (MC/UC) 92. Further, in a case in which an NACK is used for the packet loss notification, only evaluation is performed, and no notification is given in the absence of packet loss.

The gathered information may be notified in units of FEC blocks. This makes it possible to efficiently include FEC correction availability information in the other additional information. The gathered information can be notified at given times, for a given number of packets, or for a given amount of received data.

### Packet Loss Control

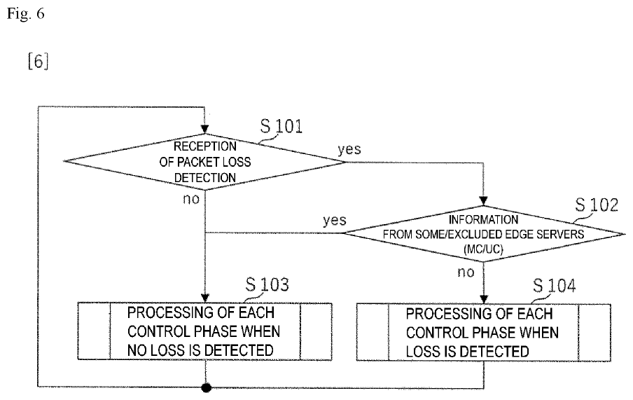

FIG. 6 illustrates an example of an operation of the edge server (UC/MC). When the edge server (UC/MC) 91 receives packet loss (yes in S101), each control phase is processed (S104) in the case of detecting loss, except in a case in which the transmission source of the packet loss is information from some/excluded edge servers (MC/UC) 92 (no in S103).

Commonly, a plurality of edge servers (MC/UC) 92 are provided as multicast distribution destinations with respect to a single edge server (UC/MC) 91. In order to control the transmission rate of multicast packets of the edge server (UC/MC) 91, if there is information of packet loss or the like only from a sufficiently small number of edge servers (MC/UC) 92 among the entire number of edge servers (MC/UC) (yes in S102), the information may not be used in rate control (S103). This can prevent excessive control over transmission rate changes caused by environment dependency of individual edge servers (MC/UC) 92.

Similarly, if there is information of packet loss or the like only from some excluded edge servers (MC/UC) 92 (yes in S102), the information may not be used in rate control (S103). This can prevent excessive control over transmission rate changes caused by environment dependency of individual edge servers (MC/UC) 92. For example, because the excluded edge servers (MC/UC) 92 are assumed to be edge servers in an unstable environment compared to non-excluded edge servers (MC/UC) 92, the quality of distribution to the other non-excluded edge servers (MC/UC) 92 can be maintained to be high by allowing the quality of distribution to the excluded edge servers (MC/UC) 92 to decrease.

### Phase Control

### Increase Phase Control

The increase phase is a phase in which a transmission rate is increased in a stepwise manner to search for an upper limit of a band.

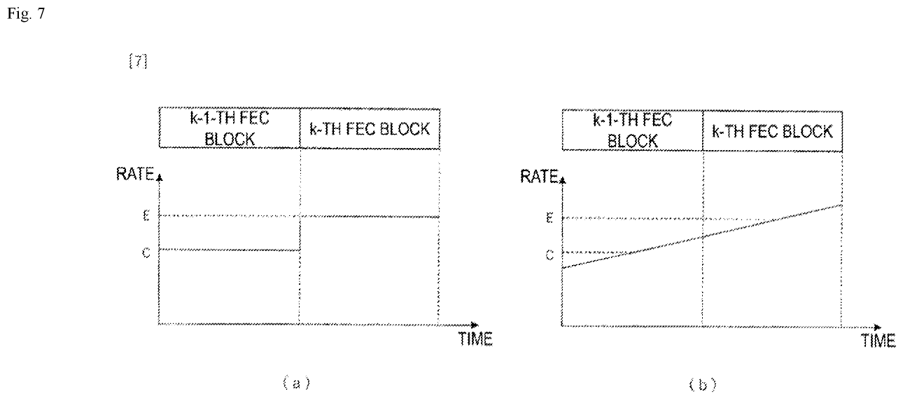

An increased transmission rate has an upper limit in the range which can be corrected in FEC, and the transmission rate is repeatedly increased for each FEC block and updated in a case in which all packets are lost due to the increased rate in one FEC block.
Here, an FEC block is a unit of error correction including data to be transferred and redundant error-corrected data.
In other words, a new FEC block satisfies the following condition (FIG. 7(a)) in a case in which FEC has an error correction capability up to loss of B [%], a transfer rate at which transmission has been possible without packet loss until the previous transmission is C [bps], and a new transfer rate E after an increase in rate is set.

(Math. 1)

E<D=C/(1−B/100) (1)

Further, either or both of E of C may increase at an average rate, rather than being constant for all of the transmitted packets in the FEC blocks (FIG. 7 (b)).

Because the rate D can be momentarily exceeded due to the set average rate, the packet loss position in the FEC blocks may be monitored to reduce the time for searching the upper limit of the network band.

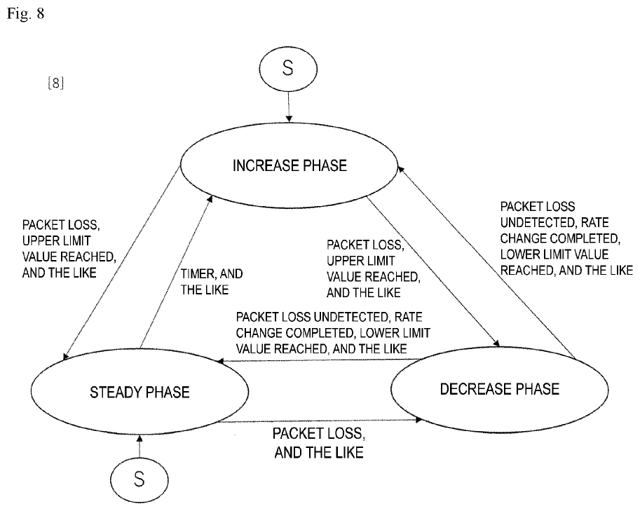

The increase phase may transition to the steady phase or the decrease phase if packet loss is detected (FIG. 8). Further, FIG. 4 illustrates an example of a transition to the steady phase. Moreover, by setting the upper limit value of the predetermined rate and reaching the set upper limit value, it is possible to transition to the steady phase or the decrease phase. It is assumed that physically an assured band and a maximum allocation band of the network are determined, and unnecessary multicast packet loss, loss of other shared packets, and compression of the band can be prevented (FIG. 8).

### Control of Steady Phase

The steady phase is a phase in which a constant transmission rate is maintained.

If the previous phase is the increase phase and the packet loss is detected at a rate exceeding F [bps], the transmission rate G of the steady phase can be set to G≤F. By setting G to a value smaller than F, a stable transfer with a transmission rate close to the upper limit and less packet loss can be achieved. Further, FIG. 4 illustrates an example in which G is set to a value smaller than F.

If the previous phase is the decrease phase and no packet loss is detected at a rate lower than or equal to H [bps], the transmission rate G of the steady phase can be set to G≤H. By setting G to a value smaller than H, a stable transfer with a transmission rate close to the upper limit and less packet loss can be achieved.

The steady phase may transition to the decrease phase if packet loss is detected (FIG. 8). This is to deal with the phenomenon in which the network state has changed and the number of available bands has decreased. As the phenomenon in which the network state has changed and the number of available bands has decreased, information such as an increase in jitter and an increase in latency of received packets may be used in addition to detection of packet loss.

In the steady phase, a timer can be used to transition to the increase phase (FIG. 8). This is to find out whether the network state has changed and the number of available bands has increased. For the phenomenon in which the network state has changed and the number of available bands has increased, information such as an decrease in jitter and a decrease in latency of received packets may be used in addition to a timer.

### Decrease Phase Control

The decrease phase is a phase in which a transfer rate is properly decreased. For control of a decreased rate, either or both of two ways of a stepwise decrease and a sudden decrease can be used.

For a stepwise decrease in a transmission rate, a transmission rate can be decreased in a stepwise manner and updated for each FEC block, contrary to the increase phase. In a case in which packet loss is no longer detected, the phase can be transitioned to the steady phase or the increase phase (FIG. 8). This operation can improve network use efficiency and reduce transfer latency, compared to the sudden decrease. In addition, in the decrease phase, an upper limit of a band can be searched for. Further, in the case of the stepwise decrease, a decreased rate of a transmission rate may not be the same rate as the opposite to that in the increase phase. In addition, it is not necessary to change the rate linearly, and control of gradually increasing or decreasing a change rate or a combination thereof may be possible.

A transmission rate due to a sudden decrease is not changed in a stepwise manner, a rate L that is greatly decreased with respect to the previous rate J can be set, and then the phase can transition to the steady phase or the increase phase with no condition (FIG. 8). Packet loss can be avoided with a high probability by greatly decreasing the rate, allowing a stable transfer with little packet loss.

The two ways can be used differentially based on information such as the previous phase, the degree of packet loss of the decrease phase, jitter of received packets, latency, etc.

Moreover, by setting a lower limit value of the predetermined rate and reaching the set lower limit value, it is possible to transition to the steady phase or the increase phase (FIG. 8). For example, in a case in which segment files of long-time moving image content are continuously acquired, the files being divided to have a two-second length, and a two-second or longer latency occurs, the content cannot be viewed without pause. In such cases, it is conceivable to set the lower limit value of the rate so that the latency continues for 2 seconds or less. Negative effects on video viewing quality caused by the decrease phase can be avoided. In addition, it is also conceivable to set a minimum assured band.

### Overall

In a case in which there are a plurality of transitionable phases, the transition phase can be determined based on past control, a packet loss history, and circuit information. For example, whether to use the steady phase is conceivable. The steady phase is used when the circuit state such as a wired circuit is stable, and when the circuit state such as a wireless circuit is likely to change, the steady phase is not used, and by using only the increase and decrease phases, an optimum rate can be constantly and continuously searched. Likewise, the steady phase can be used because the circuit state is stable when priority control is performed as the QoS, and the steady phase may not be used in the case of best-effort because the circuit state is unstable.

An initial phase can be the increase phase or the steady phase (FIG. 8). In a case in which the speed increase phase is the initial phase, the upper limit rate can be rapidly searched for when an initially set rate is sufficiently lower than the upper limit rate, and as a result, a latency time can be shortened. In a case in which the steady phase is the initial phase, a transfer can be stably performed when the initially set rate is sufficiently close to the upper limit rate based on the past control history.

### Apparatus Configuration

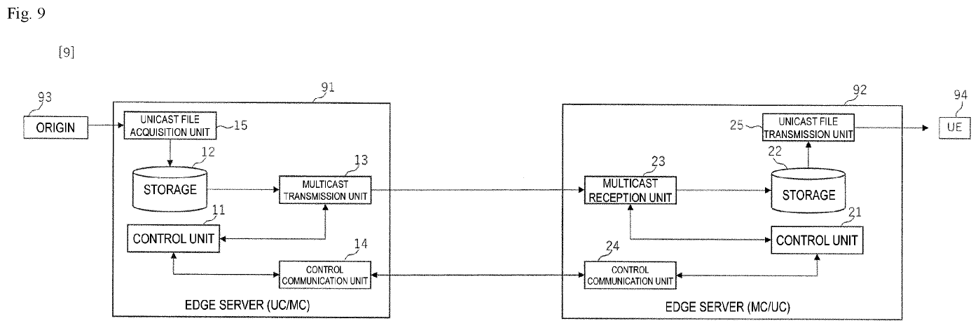

An exemplary configuration of the edge server (UC/MC) 91 and the edge server (MC/UC) 92 for implementing the above-described systems is illustrated in FIG. 9. However, other configurations may be used to implement the system described above.

The edge server (UC/MC) 91 includes a unicast file acquisition unit 15, a storage 12, a multicast transmission unit 13, a control unit 11, and a control communication unit 14. The edge server (UC/MC) 91 can be realized by a computer and a program, and the program can be recorded on a recording medium or provided through a network.

The unicast file acquisition unit 15 can acquire files from the origin 93 in unicast communications and store it in the storage 12.
The storage 12 is a computer resource that can store data, such as a HDD, an SSD, a memory, or the like.
The multicast transmission unit 13 can read files from the storage 12 and transmit the files as multicast packets according to an instruction from the control unit 11. Furthermore, FEC information can be added to the transmission data. In addition, the multicast transmission unit 13 can change a transmission rate according to an instruction from the control unit 11.
The control communication unit 14 can receive a notification such as the (1) network/server information notification, the (2) file request, the (4) packet loss information, and the like from a control communication unit 24 of the edge server (MC/UC) 92 illustrated in FIG. 5 to notify the control unit 11 of the information and can send the (5) reception notification of the packet loss information, or the like according to an instruction from the control unit 11.
The control unit 11 can perform the above-described control over the multicast transmission unit 13 and the control communication unit 14.

The edge server (MC/UC) 92 includes a unicast file transmission unit 25, a storage 22, a multicast reception unit 23, a control unit 21, and the control communication unit 24. The edge server (MC/UC) 92 can be realized by a computer and a program, and the program can be recorded on a recording medium or provided through a network.

The unicast file transmission unit 25 can transmit files in the storage 22 to the UE 94 in unicast communication.
The storage 22 is a computer resource that can store data, such as a HDD, an SSD, a memory, or the like.
The multicast reception unit 23 can receive files from the multicast transmission unit 13 and write the files into the storage 22. In addition, the control unit 21 can be notified of information related to reception states such as packet loss information. Further, the control unit 11 can be notified of information based on a request from the control unit 21. In addition, received data may be subject to error correction and detection using FEC information.
According to an instruction from the control unit 21, the control communication unit 24 can transmit a notification such as the (1) network/server information notification, the (2) file request, and the (4) packet loss information described in FIG. 5, receive the (5) reception notification of packet loss information from the control communication unit 14 of the edge server (UC/MC) 91, and notify the control unit 21 of the information.
The control unit 21 can perform the above-described control over the multicast reception unit 23 and the control communication unit 24.

### Effects Obtained from the Present Disclosure

Multicast packets can be transferred to at as high a rate as possible according to a network state (a traffic amount, an available band, etc.) for transmitting the multicast packets from the edge server (UC/MC) 91 to the edge servers (MC/UC) 92. Therefore, transfer with low latency can be realized.

Stable viewing with high QoE can be realized by avoiding an unnecessary transition to viewing with low image quality caused by ABR or the like at the time of viewing of HTTP streaming with low latency.
In addition, stable multicast distribution on a network that is less likely to ensure a fixed available band at a high rate, such as a best-effort or wireless network, can also be achieved. In particular, multicast distribution of a large volume of content, such as moving images with high image quality, can be achieved.

### Points of the Present Disclosure

When the number of viewers is large, live HTTP streaming tends to generate a load with a peak on a distribution server or network, and thus QoE in viewing the video is easily deteriorated.
On the other hand, while the technique proposed in the past to convert the communication of some sections of data into multicast communication exhibits the effect of reducing an amount of traffic, a transfer latency easily increases at the multicast transfer portion.
According to the present disclosure, forward error correction (FEC) is added to multicast packets to be transmitted, a transfer rate is dynamically changed in the correctable range, and thus a low-latency multicast transfer is achieved.

Therefore, it possible to improve QoE in viewing moving images and the like. In addition, high-rate transfers on unstable networks that have failed to achieve high-speed multicast transfers of large volumes of data can be achieved.

### REFERENCE SIGNS LIST

91 Edge server (UC/MC)
11 Control unit
12 Storage
13 Mar control communication unit
14 Ticast transmission unit
15 Unicast file acquisition unit
21 Control unit
22 Storage
23 Multicast reception unit
24 Control communication unit
25 Unicast file transmission unit
92 Edge server (MC/UC)
93 Origin
94 UE

1. A content distribution system for converting part of communication for distribution into multicast communication, the content distribution system comprising:
a transmission-side edge server configured to convert unicast communication into multicast communication and perform transmission to a multicast communication network; and
a reception-side edge server configured to convert multicast communication transmitted on the multicast communication network into unicast communication,
wherein the transmission-side edge server applies Forward Error Correction to a multicast packet and transmits the multicast packet,
the reception-side edge server notifies the transmission-side edge server of information of packet loss of the received multicast packet, and
the transmission-side edge server changes a transfer rate of a multicast packet to be transmitted based on the notified information of packet loss.

2. A content distribution method performed by a content distribution system for converting part of communication for distribution into multicast communication, the content distribution system including a transmission-side edge server configured to convert unicast communication into multicast communication and perform transmission to a multicast communication network, and
a reception-side edge server configured to convert multicast communication transmitted on the multicast communication network into unicast communication,
wherein the transmission-side edge server applies Forward Error Correction to a multicast packet and transmits the multicast packet,
the reception-side edge server notifies the transmission-side edge server of information of packet loss of the received multicast packet, and
the transmission-side edge server changes a transfer rate of a multicast packet to be transmitted based on the notified information of packet loss.

3. An edge server apparatus included in a content distribution system for converting part of communication for distribution into multicast communication, the edge server apparatus being
a transmission-side edge server configured to convert unicast communication into multicast communication and perform transmission to a multicast communication network,
wherein the edge server apparatus applies Forward Error Correction to a multicast packet to be transmitted to the multicast communication network, and
when the edge server apparatus receives information of packet loss of a multicast packet from a reception-side edge server configured to convert multicast communication transmitted on the multicast communication network into unicast communication, the edge server apparatus changes a transfer rate of the multicast packet to be transmitted to the multicast communication network based on the received information of packet loss.

4. (canceled)

5. A non-transitory computer-readable medium having computer-executable instructions that, upon execution of the instructions by a processor of a computer, cause the computer to function as the edge server apparatus according to claim 3.
